(19) United States
(12) Patent Application Publication
(10) Pub. No.: US 2008/0090595 A1
(43) Pub. Date: Apr. 17, 2008

(54) NEAR FIELD COMMUNICATION FOR PROFILE CHANGE IN SWITCHING NETWORK ACESS

(75) Inventors: Charles Liu, Chapel Hill, NC (US); L. Scott Bloebaum, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/548,331

(22) Filed: Oct. 11, 2006

(51) Int. Cl. H04Q 7/20

(52) U.S. Cl. 455/461

(57) ABSTRACT

Disclosed is a system and method that utilizes near field communications (NFC) for establishing and/or controlling the routing of communications in a fixed mobile convergence environment. Electronic equipment is provided with an NFC adapter and a storage element (e.g., memory, disk drive, etc.) that has user's identity specific information (e.g., user's identity information, social security number, user's identity identification number, virtual target network (VPN) settings, etc.) stored in a suitable electronic format for transmission to a NFC reader that is coupled to a fixed local network (e.g., corporate enterprise network). The fixed local network authenticates the user and fixed mobile convergence is realized between a wide area communication network and the fixed local area network.

### TECHNICAL FIELD OF THE INVENTION

The present invention relates to a system and method for controlling and/or establishing multi-network access using near field communications.

### DESCRIPTION OF THE RELATED ART

Electronic equipment, such as, for example, communication devices, mobile phones, personal digital assistants, etc. are typically equipped to communicate with mobile communications devices over communication networks. Such electronic equipment are increasingly being equipped with adapters to support advanced communications in a variety of mediums. Such advanced communication mediums may include, for example, Bluetooth, 802.11, wireless local area networks (WLANs), WiFi and WiMax. Electronic equipment capable of communication in a plurality of mediums are commonly referred to as dual mode electronic equipment (e.g., dual mode mobile communications devices).

Another communication medium currently being implemented in electronic equipment is near field communication (NFC). The use of NFC interfaces in electronic equipment provides portable devices with functions similar to those of non-contact integrated circuit cards (e.g., radio frequency identification (RFID) cards). In addition, electronic equipment provided with NFC interfaces are typically capable of operating as radio frequency readers and/or writers to communicate with other NFC devices.

Multi-mode electronic equipment are equipped with radio technologies to access more than one type of wireless networks (e.g., conventional wide-area wireless networks such as, GSM, UMTS, CDMA, etc., and other wireless data networks such as WiFi, WiMax, Bluetooth, etc.). Subscribers with multi-mode mobile communications devices can access and utilize a variety of network types according to the types of wireless network adapters that are present in the particular devices. For example, some devices may have two network access adapters, one supporting a conventional wide-area wireless technology and a second supporting a local-area wireless technology. In such a case, the user of the device may be able to seamlessly roam between a wide-area network and a local-area network, which enables services often referred to “fixed mobile convergence” or FMC. An example of an FMC service is having one telephone number for making and receiving calls from both the wide-area wireless and the fixed-line public network via a wireless local-area network.

One difficulty in the implementation of FMC and multi-network access in general is determining when the user leaves one network and enters another network, or when switching between networks becomes desirable or necessary. For example, when the users enters a local or private area where the user is covered by a wireless local area network (WLAN) or similar local connectivity wireless technologies, and when the user is actually moving from a local or private area into a public or true mobile domain (e.g., covered only by the wide-area wireless network). Another difficulty in implanting FMC multi-network access in general is the initial securing of information exchange between the mobile device and the network for the purpose of gaining network access with quick, easy, and secure user experience.

### SUMMARY

In view of the aforementioned shortcomings associated with the implementation of multi-network access in general, there is a strong need in the art for a mechanism to implement multi-network access in assisting the transition of the network access when user moves between two different and independent networks, in which pertinent information is unambiguously transferred from the electronic equipment to the specific network using a suitable NFC interface.

One aspect of the present invention is directed to a method for enabling multi-network usage of a mobile communications device, the method comprising: providing a mobile communications device for access to a plurality of wireless networks, each with separate user access domains, the mobile communications device including a plurality of wireless network adapters for access the plurality of wireless networks, a near field communication (NFC) adapter, and a storage medium for storing network-specific user profile information to access a target network that is among the plurality of wireless networks; transmitting a request for access to the target network, wherein the request is transmitted upon placing the mobile communications device within an operable distance from an associated NFC device, wherein the associated NFC device is communicably coupled to the target network.

Another aspect of the invention is directed to the request including at least a portion of the user's identity information stored on the mobile communications device.

Another aspect of the invention is directed to the request including a user profile of the associated user of the private network.

Another aspect of the invention is directed to network specific user profile information being transferred from the target network to the mobile communications device through a near field communication protocol.

Another aspect of the invention is directed to the network specific user profile information being transferred from the target network to the mobile communications device through a wireless communication medium.

Another aspect of the invention is directed to receiving an acknowledgement that the request for access to the private network has been granted.

Another aspect of the invention is directed to disabling access to at least one other wireless network adapters upon receiving access to the target network.

Another aspect of the invention is directed to receiving and transmitting communication signals with the associated target network through a wireless local area network (WLAN) adapter.

Another aspect of the invention is directed to placing a telephone call from the mobile communications device wherein the telephone call is transmitted through a virtual target network (VPN) packet-switched connection established with the associated target network through the WLAN adapter.

Another aspect of the invention is directed to 10 exchanging data between the mobile communications device and the associated target network through a wireless local area network (WLAN) adapter.

Another aspect of the invention is directed to the data including at least one item selected from the group consisting of: electronic mail (E-mail) messages, electronic calendar information, presence information or synchronization information.

Another aspect of the invention is directed to the data being push delivered from the target network to the WLAN adapter of the mobile communications device.

Another aspect of the invention is directed to routing both outgoing calls originating from the mobile communications device and incoming calls to the mobile communications device through a wireless local area network (WLAN) adapter for output through the target network in packet form.

One aspect of the invention relates to a method of enabling fixed mobile convergence, the method comprising: providing a target network including at least one input device for receiving near field communication (NFC) signals from an associated mobile communications device; receiving a request for access to the target network from the associated mobile communications device, wherein the request is transmitted upon placing the associated mobile communications device within an operable distance from an NFC device; authenticating the request; and transferring an user's identity information from the associated mobile communications device to the target network.

Another aspect of the invention is directed the request including user identity information associated with a user of the mobile communications device.

Another aspect of the invention is directed to the step of authenticating the request is based at least in part on the user's identity information transmitted in the request.

Another aspect of the invention is directed to outputting an audio and/or video signal to the associated user of the mobile communications device that the request for access to the associated target network has been granted.

Another aspect of the invention is directed to the user's identity information including at least one item selected from the group consisting of: an user's identity name, a social security number, a user's identity number, a user profile or a unique identification associated with the user of the mobile communications device network.

Another aspect of the invention is directed to the user's identity information including information to provide access to data from the target network to at least one data item selected from the group consisting of: electronic mail (E-mail) information, calendar information, virtual target network information, presence information or voice over Internet Protocol (VoIP) information.

Another aspect of the invention is directed to push delivery of data from the target network to the associated mobile communications device.

Another aspect of the invention is directed to the data being transmitted to the associated mobile communications device through a wireless local area network (WLAN) interface.

Another aspect of the invention is directed to the target network receives information originating from telephone call from an electronic device and outputs the telephone call information to the associated mobile communications device through a wireless local area network (WLAN) interface.

One aspect of the invention relates to a mobile communications device comprising: a storage element for storing user identity information that facilitates fixed mobile convergence between a first network and a second network; a near field communication (NFC) adapter; a processor coupled to the storage element and the NFC adapter, wherein the processor is operable to control transferring of user network specific profile information to the NFC adapter when an associated NFC reader is within an operable distance to the mobile communications device, wherein the NFC adapter triggers transferring the user network specific profile when the mobile communications device moves from the first network to the second network.

Another aspect of the invention is directed to the storage element being removable.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal, includes all equipment such as mobile communications devices, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1 and 2 are exemplary schematic diagrams illustrating electronic equipment in accordance with aspects of the present invention.

FIG. 3 is an exemplary illustration of a near field communication system in accordance with aspects of the present invention.

FIG. 4 is schematic block diagram of an exemplary multi-network access system in accordance with aspects of the present invention.

FIGS. 5-8 illustrate exemplary methods in accordance with aspects of the present invention.

### DETAILED DESCRIPTION OF EMBODIMENTS

The present invention is directed to a system and method that utilizes near field communications (NFC) for establishing and/or controlling the routing of communications in a multi-network environment. Electronic equipment, sometimes referred to herein as a communication device, mobile telephone, mobile communications device, and portable telephone is provided with an NFC adapter and a storage element (e.g., memory, disk drive, etc.) that includes information related to the user's identity and the network specific profile information (e.g., user name, password, social security number, user's identification number, virtual private network (VPN) settings, etc.) stored in a suitable electronic format for transmission to a NFC reader.

In one aspect of the invention, when the user of multi-network access technologies enters a domain where another type of network (e.g. fixed local network with wireless access)—referred to in the following description as the “target network”—becomes available, the user simply places his or her electronic equipment in communication with an NFC reader connected to the target network. The target network receives the user's identity and the network specific profile information stored in the electronic equipment. The target network authenticates the user and permits the user's electronic equipment to access target network resources. The user then switches from one type of network to the target network with the corresponding profile loaded and configured. The user is capable of receiving and making voice calls and data connections with the electronic equipment routed through the target network.

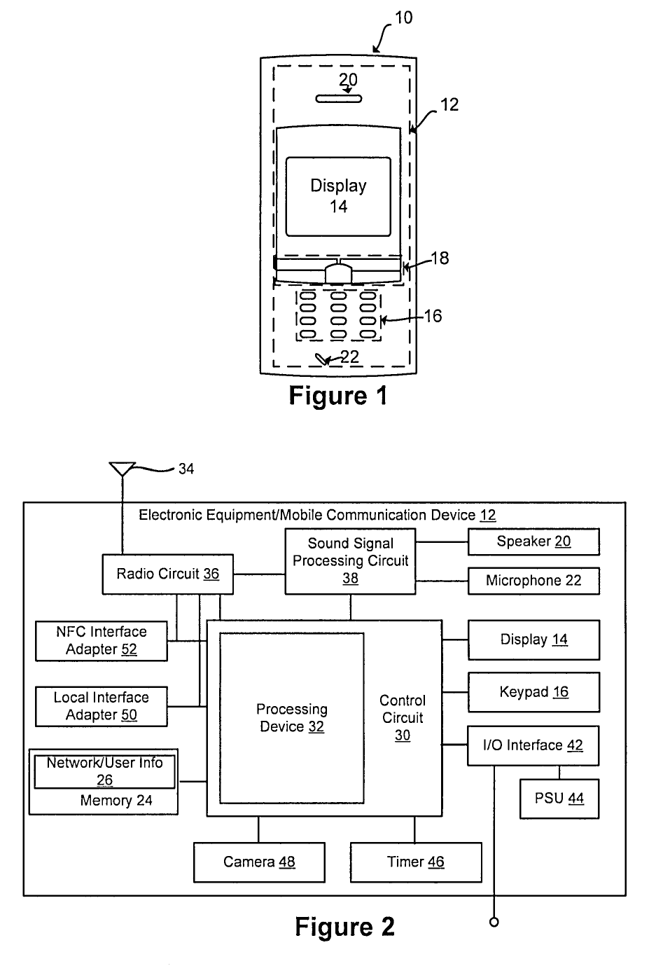

Referring to FIG. 1, electronic equipment 10 is shown in accordance with the present invention. The electronic equipment 10 in the exemplary embodiment is a mobile communications device and will be referred to as the mobile communications device 10. The mobile communications device 10 is shown as having a “brick” or “block” design type housing, but it will be appreciated that other type housings, such as clamshell housing or a slide-type housing, may be utilized without departing from the scope of the invention.

As illustrated in FIG. 1, the electronic equipment 10 may include a user interface 12 (identified by dotted lines) that enables the user easily and efficiently to perform one or more communication tasks (e.g., identify a contact, select a contact, make a telephone call, receive a telephone call, establish and manage NFC-related exchanges of information, etc). The user interface 12 of the electronic equipment 10 generally includes one or more of the following components: a display 14, an alphanumeric keypad 16, function keys 18, a navigation tool 19, a speaker 20, and/or a microphone 22.

The mobile communications device 10 includes a display 14. The display 14 displays information to a user such as operating state, time, telephone numbers, contact information, various navigational menus, status of one or more functions, etc., which enable the user to utilize the various features of the mobile communications device 10. The display 14 may also be used to visually display content accessible by the mobile communications device 10. The displayed content may include E-mail messages, audio and/or video presentations stored locally in memory 24 (FIG. 2) of the mobile communications device 10 and/or stored remotely from the mobile communications device 10 (e.g., on a remote storage device, a mail server, remote personal computer, etc.). Such presentations may be derived, for example, from NFC-related exchanges of information, from multimedia files received through E-mail messages, including audio and/or video files, from a received mobile radio and/or television signal, etc. The audio component may be broadcast to the user with a speaker 20 of the mobile communications device 10. Alternatively, the audio component may be broadcast to the user though a headset speaker (not shown).

The mobile communications device 10 further includes a keypad 16 that provides for a variety of user input operations. For example, the keypad 16 may include alphanumeric keys for allowing entry of alphanumeric information such as user-friendly identification of contacts, user-friendly identification of contacts, E-mail addresses, distribution lists, telephone numbers, phone lists, contact information, notes, etc. In addition, the keypad 16 typically may include special function keys such as a “call send” key for transmitting an E-mail, initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile communications device 10 may include a volume key, audio mute key, an on/off power key, a web browser launch key, an E-mail application launch key, a camera key, etc. Keys or key-like functionality may also be embodied as a touch screen associated with the display 14.

The mobile communications device 10 also includes conventional call circuitry that enables the mobile communications device 10 to establish a call, transmit and/or receive E-mail messages, and/or exchange signals with a called/calling device, typically another mobile communications device or landline telephone. However, the called/calling device need not be another telephone, but may be some other electronic device such as an NFC-compliant electronic device, Internet web server, E-mail server, content providing server, etc.

Referring to FIG. 2, an exemplary functional block diagram of the mobile communications device 10 is illustrated. The mobile communications device 10 includes a primary control circuit 30 that is configured to carry out overall control of the functions and operations of the mobile communications device 10. The control circuit 30 may include a processing device 32, such as a CPU, microcontroller or microprocessor. The processing device 32 executes code stored in a memory (not shown) within the control circuit 30 and/or in a separate memory, such as memory 24, in order to carry out operation of the mobile communications device 10. The processing device 32 is generally operative to perform all of the functionality disclosed herein. For example, the processing device 32 is coupled to the storage element (e.g., memory 24) and the NFC adapter 52 and is capable of controlling the transfer of user's identity information to the NFC adapter when an associated NFC reader is within an operable distance to the mobile communications device.

The memory 24 may be, for example, a buffer, a flash memory, a hard drive, a removable media, or some other type of volatile and/or a non-volatile memory. In addition, the processing device 32 executes code to carry out various functions of the mobile communications device 10.

Continuing to refer to FIGS. 1 and 2, the mobile communications device 10 includes an antenna 34 coupled to a radio circuit 36. The radio circuit 36 includes a radio frequency transmitter and receiver for transmitting and receiving signals via the antenna 34 as is conventional. The mobile communications device 10 generally utilizes the radio circuit 36 and antenna 34 for voice, Internet and/or E-mail communications over a cellular telephone network. The mobile communications device 10 further includes a sound signal processing circuit 38 for processing the audio signal transmitted by/received from the radio circuit 36. Coupled to the sound processing circuit 38 are the speaker 20 and a microphone 22 that enable a user to listen and speak via the mobile communications device 10 as is conventional. The radio circuit 36 and sound processing circuit 38 are each coupled to the control circuit 30 so as to carry out overall operation.

The mobile communications device 10 also includes the aforementioned display 14 and keypad 16 coupled to the control circuit 30. The mobile communications device 10 further includes an I/O interface 42. The I/O interface 42 may be in the form of typical mobile communications device I/O interfaces, such as a multi-element connector at the base of the mobile communications device 10. As is typical, the I/O interface 42 may be used to couple the mobile communications device 10 to a battery charger to charge a power supply unit (PSU) 44 within the mobile communications device 10. In addition, or in the alternative, the I/O interface 42 may serve to connect the mobile communications device 10 to a wired personal hands-free adaptor, to a personal computer or other device via a data cable, etc. The mobile communications device 10 may also include a timer 46 for carrying out timing functions. Such functions may include timing the durations of calls, generating the content of time and date stamps, etc.

The mobile communications device 10 may include various built-in accessories, such as a camera 48 for taking digital pictures. Image files corresponding to the pictures may be stored in the memory 24. In one embodiment, the mobile communications device 10 also may include a position data receiver (not shown), such as a global positioning satellite (GPS) receiver, Galileo satellite system receiver or the like.

To establish wireless communication with a variety of types of wireless networks, mobile communications device 10 may include a plurality of wireless network adapters. In some embodiments, one of the plurality of wireless network adapters may include a wireless local area network (WLAN) adapter 50, which enables mobile communications device 10 to communicate with other nearby WLAN-equipped devices or WLAN access points Preferably, the WLAN adapter 50 is compatible with one or more IEEE 802.11 protocols (e.g., 802.11(a), 802.11(b) and/or 802.11(g), etc.) and allows the mobile communications device 10 to acquire a unique address (e.g., IP address) on the WLAN and communicate with one or more devices on the WLAN and fixed local network and/or other devices located remotely from the WLAN (e.g., remote computers, mobile phones, etc.) using one or more protocols (e.g., Internet Protocol, VoIP, SMP, IM, etc.), assuming the user has the appropriate privileges and/or has been properly authenticated.

To establish near field communications (NFC) with other electronic devices in close proximity, such as an NFC-enabled and/or NFC-compliant electronic devices and the like, the mobile communications device 10 may further include an NFC interface adapter 52. As used herein, the phrases “NFC-enabled” and “NFC-compliant” may be used interchangeably and refer to devices that are capable of communicating with other devices using one or more near field communication protocols. Preferably, the NFC interface adapter 52 is compatible with one or more NFC related protocols and allows the mobile communications device 10 to communicate with other NFC-enabled and/or compliant devices. As used herein, the phrase “near field communication” and its acronym “NFC” fully comprises all of the communication features and functions associated with radio frequency identification (RFID) and any other near field communication protocols.

Among the plurality of wireless network adapters, the mobile communications device 10 may also include one or more wireless wide-area network (WWAN) adapters that enable the mobile communications device 10 to communicate with compatible wide-area WWAN's based on technologies such as 2G or 3G cellular, WiMax, WiBro, or the like. The WWAN can include or be communicably coupled to a server or servers for managing calls, Internet access and/or E-mails placed by and/or destined to the mobile communications device 10, transmitting content (e.g., image files, audio files, video files, etc.) to and/or from the mobile communications device 10 and carrying out any other support functions. The server generally communicates with the mobile communications device 10 via a network and a transmission medium. The transmission medium may be any appropriate device or assembly, including, for example, a communications tower, another mobile communications device, a wireless access point, a satellite, etc. Portions of the network may include wireless transmission pathways.

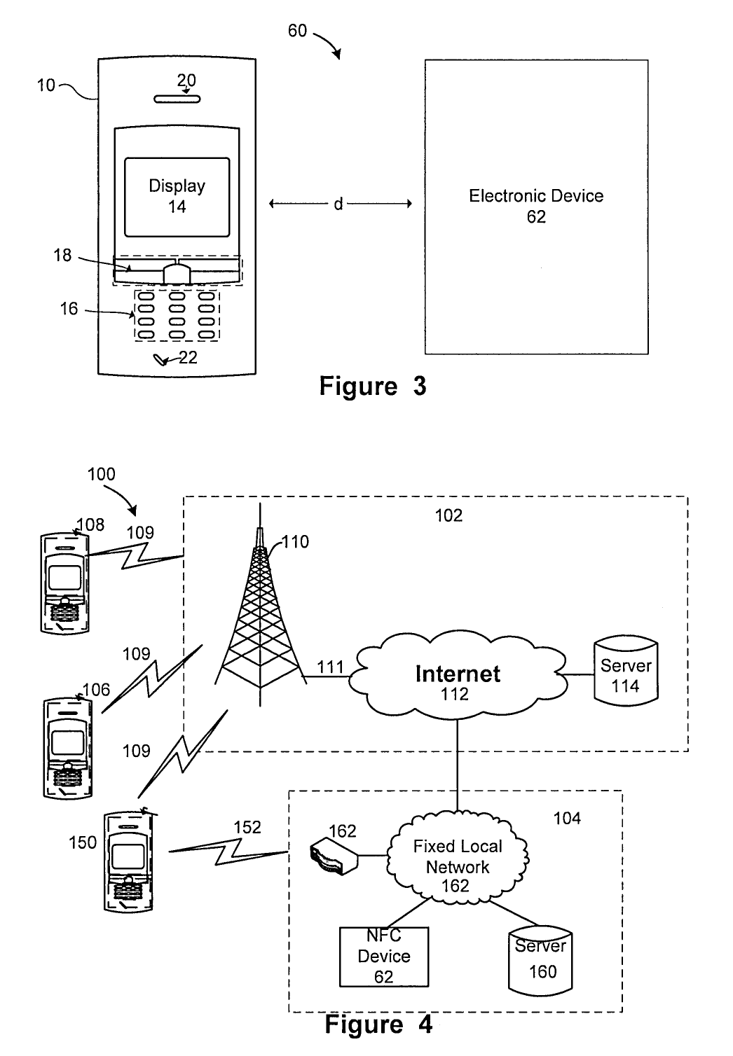

FIG. 3 illustrates an exemplary near-field communication system 60 in accordance with the present invention. The system 60 consists of a mobile communications device 10 and an electronic device 62. The electronic device 62 may be any electronic device having NFC capabilities. For example, the electronic device 62 may be a NFC reader and/or scanner, a personal digital assistant (PDA), a personal computer (PC), a mobile communications device, a wristwatch, a pen, or other communication device. The mobile communications device 10 and the electronic device 62 are adapted to perform near field communication based on electromagnetic induction making use of the carrier waves of a single frequency with other NFC apparatuses. The frequency of the carrier waves used by the mobile communications device 10 and the electronic device 62 may be any suitable frequency. For example, one such suitable frequency is 13.56 MHz, which is in the industrial scientific medical (ISM) band.

As one of ordinary skill in the art will appreciate, near field communication means the communication that can be accomplished when the distance “d”, as illustrated in FIG. 3, between communicating apparatuses is several tens of centimeters or less, and it includes the communication accomplished through the contact between communicating apparatuses or between their housings.

The communication system illustrated in FIG. 3 may be used as an IC card system in which one or more of the NFC-compliant devices (e.g. mobile communications device 10 and electronic device 62 function as readers/writers, while the remaining one or more function as IC cards. Generally, NFC-compliant devices permit communication in two communication modes (e.g., active and passive modes) and also permit data transmission at a plurality of transmission rates.

In the passive mode, the mobile communications device 10 may modulate the carrier waves corresponding to the electromagnetic waves that it generates, so as to send data to the electronic device 62. The electronic device 62 generally modulates the carrier waves corresponding to the electromagnetic waves generated by the mobile communications device 10 and sends the resulting information, in the form of a NFC tag to the mobile communications device 10.

In the active mode, mobile communications device 10 and electronic device 62 both modulate the carrier waves corresponding to the electromagnetic waves generated by themselves so as to send information (e.g., NFC tags). When the near field communication based on electromagnetic induction is performed, the apparatus that outputs electromagnetic waves first to initiate the communication and may be said to take the initiative is called an initiator. The initiator transmits a command to a communicating party, and the communicating party sends a response associated with the command so as to establish the near field communication. The communicating party who receives the command from the initiator is called the “target”. For example, if mobile communications device 10 initiates the outputting of electromagnetic waves to start communication with the electronic device 62, then the mobile communications device 10 will be the initiator and the electronic device 62 will be the target.

In the passive mode, the mobile communications device 10, which is the initiator, continues outputting electromagnetic waves. The mobile communications device 10 modulates the electromagnetic waves generated by itself so as to send data to the electronic device 62. The electronic device 62 carries out load-modulation on the electromagnetic waves output from the mobile communications device 10, which is the initiator, and sends information to the mobile communications device 10.

In the active mode, when the mobile communications device 10 sends information, it generally first starts outputting electromagnetic waves by itself, and modulates the generated electromagnetic waves so as to send data to the target, i.e., the electronic device 62. The mobile communications device 10 may stop outputting electromagnetic waves after the completion of the transmission of data. When the electronic device 62, which is the target, sends data, it initiates the outputting of electromagnetic waves by itself, and modulates the electromagnetic waves so as to send data to the mobile communications device 10. The electronic device 62 may terminate the output of the electromagnetic waves after the transmission of data is finished. One of ordinary skill in the art will readily appreciate that the above discussion is exemplary in nature and the precise operation and/or interactions of NFC devices may vary from what is described.

Aspects of the present invention relate to storing user's identity information (e.g., network-specific profiles or information, virtual private network (VPN) profile, communication profiles, etc.) in a storage element of the mobile communications device 10. For example, the information may be stored in memory 24, as denoted by reference numeral 26 in FIG. 2. The information may also be stored on a disk drive or other suitable device (not shown).

The information may be transferred to the electronic device 62 in any desirable manner (e.g., as an NFC tag, as a data stream, individually, collectively, etc.) through the NFC adapter 52 to the electronic device 62. The information may be transmitted automatically upon when a NFC device is detected or when queried by the electronic device 62.

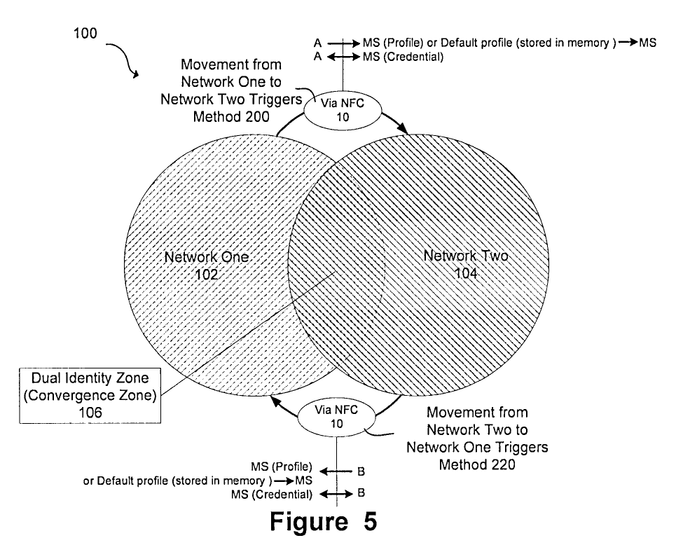

FIG. 4 illustrates an exemplary multi-network access system 100 in accordance with aspects of the present invention. As illustrated, the multi-network access system 100 includes a mobile network 102 and a fixed second network 104. Operation of the various networks will be discussed separately and then combined as in an FMC system.

In the first example, mobile communications device 106 initiates a call to mobile communications device 108 through a wireless communication medium 109. The call utilizes a wireless wide area network base station 110 to facilitate such communication between the two devices, as is conventional. As another example, mobile communications device 106 desires to access the Internet 112 and/or seek content and/or applications from server 114. In such a case, a request is sent wirelessly from the mobile communications device 106 to the wireless wide-area network (WWAN) base station 110 and routed to one or more application servers (e.g., Internet 112 and/or server 114) through what is generally a wired communication medium 111. Once this connection has been established, mobile communications device 106 can effectively communicate with one more devices associated with the Internet 112 and/or server 114.

In the fixed second network 104 (e.g., a corporate enterprise environment, warehouse, home office, etc.), mobile communications device 150 may communicate with devices outside the fixed second network 104. For example, mobile communications device 150 may utilize a wireless communication link 109 to communicate with other mobile devices (e.g. mobile communications device 106, mobile communications device 108, landline telephones not shown, computers, etc.). Mobile communications device 150 may also communicate with wireless local area network access point 162 through a wireless network adapter 50 (shown in FIG. 2) having a suitable communication link 152. For example, the mobile communications device 150 may communicate with devices located in the local network 162, as well as server 160, using a suitable communication medium.

The mobile communications device may also utilize the wireless network adapter 50 to communicate with devices outside of the fixed second network 104. For example, mobile communications device 150 may communicate with mobile communications device 108 through WLAN communications using voice over IP (VoIP) or some other suitable communication protocol. The communication link may be secured or unsecured depending on the precise application and/or communication made. In one embodiment, a virtual target network is established between the mobile communications device 150 for secure network communications between the mobile communications device 150 and the called device while in the fixed local network. In another embodiment, the communication between the mobile communications device 150 and the various networks may also be encrypted.

As shown in FIG. 4, a near field communication (NFC) device 62 is also provided. As stated above, the electronic device 62 may be any electronic device having NFC capabilities. For example, the electronic device 62 may be a NFC reader and/or scanner, a personal digital assistant (PDA), a personal computer (PC), a mobile communications device, a wristwatch, a pen, or other communication device.

The NFC device 62 is coupled to the local area network 162. As explained in detail below, NFC device 62 provides a mechanism for the user of mobile communications device 150 to signal to the various networks that the user is currently present in a fixed second network 104, which allows the mobile communications device 150 to communicate with devices outside of fixed local network through various Internet applications, instead of the mobile network 102. A benefit associated with this is cost saving from reduced transmission and reception of voice and data over the mobile network 102.

There are also efficiency benefits associated with this increased functionality. For example, when the user is in the fixed local network environment, network communications and voice communications may be routed to the user's mobile communications device so that the user's mobile communications device becomes a mobile computer that allows the user to interact with e-mails, calendar functions, voice communications, etc. just as if the user were sitting as his/her computer in the office. Preferably, push delivery of data from the fixed local network environment is utilized to transfer data to mobile communications device 10. Push technology provides a fast and efficient way for the mobile communications device 10 to be synchronized with the user's workstation computer and/or network. Another benefit is the ability for others to contact the user simply by calling one number instead of first trying the office phone number and then trying the user's mobile communications device number. In this case, the third party simply calls one number and the call is routed to the user no matter which numbers called.

One of ordinary skill in the art will readily appreciate that the above examples are not exhaustive and that multi-network access may evolve over time to include a variety of functionality not presently discussed and/or known. All such functionality is deemed to be within the scope of the present invention.

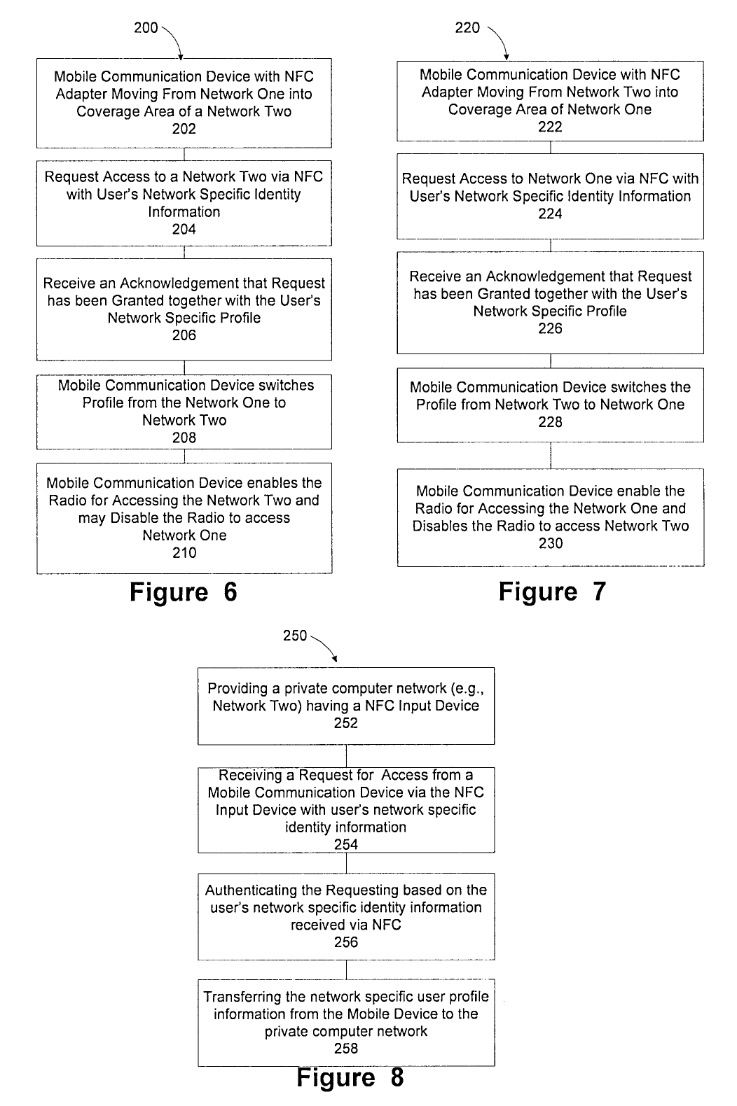

Referring to FIGS. 5-7, exemplary methods for enabling multi-network access are shown. Referring to FIG. 5, a system 100 is illustrated. The system 100 includes a first network 102 and second network 104. Users operating their mobile communications device solely within the first network 102 will generally use the first network 102 for communication functions. Likewise, users operating their mobile communications device solely within the second network 104 will generally use the second network 104 for communication functions. Convergence area 106 is the area of overlap between the first network 102 and the second network 104 where users may utilize either the first network 102 and/or the second network 104 for communication functions.

Referring to FIG. 6, an exemplary method 200 for enabling multi-network access is shown. In method 200, it is assumed that the user is using the communication resources of the first network 102 is about to enter the second network 104. At step 202, a mobile communications device is provided that includes a first wireless network adapter (e.g. radio circuit 36), a near field communication (NFC) adapter 52, a second wireless network adapter (which in this embodiment is wireless local area network (WLAN) adapter 50), and a storage medium (e.g., memory 24) for storing user's identity information (e.g., social security number, user's identity identification number, virtual target network (VPN) settings, etc.) to enable multi-network access. The storage medium may be any suitable storage medium (e.g., memory 24, disk drive, etc.). Preferably, the storage medium is housed within the mobile communications device.

At step 204, a request for access to the second network 104 (e.g., a corporate computer network, a corporate telephone network, etc.) is transmitted by the mobile communications device 10 to the electronic device 62. The request is transmitted upon contacting and/or placing the mobile communications device within an operable distance from an associated NFC reader 62. The request may include at least a portion of the user's identity information and is transmitted through the NFC interface adapter 52 to the NFC reader 62. The request may also include a user profile of the associated user.

Optionally, at step 206, the mobile communications device may receive an acknowledgement that the request for access to the second network 104 has been granted. At step 208, the mobile communications device switches the profile from the first network 102 to the second network 104.

At step 210, upon successful authentication by the second network 104, the radio circuit 36 may be disabled or its usage inhibited in some other manner. Voice and data communications with the mobile communications device are received and transmitted with the associated computer network through the wireless network adapter used to access the second network 104 (e.g., WLAN adapter 50). Preferably, when the user of the mobile communications device places a call, the telephone call is transmitted in packet form through a virtual private network (VPN) connection with the associated computer network in order to increase security.

Another exemplary method 220 is illustrated in FIG. 7. In method 220, it is assumed that the user is using the communication resources of the second network 104 and is about to leave the second network 104 for entry into the first network 102. At step 222, a mobile communications device is provided that includes a first wireless network adapter (e.g. radio circuit 36), a near field communication (NFC) adapter 52, a wireless network adapter (e.g., WLAN adapter 50) and a storage medium (e.g., memory 24) for storing user's identity information (e.g., social security number, user's identity identification number, virtual private network (VPN) settings, etc.) to enable multi-network access.

At step 224, a request for access to the first network 102 (e.g., mobile communication network, cellular network, etc.) is transmitted by the mobile communications device 10 to the electronic device 62 (shown in FIG. 3). The request is transmitted upon contacting and/or placing the mobile communications device within an operable distance from an associated NFC reader 62. The request may include at least a portion of the user's identity information and is transmitted through the NFC interface adapter 52 to the NFC reader 62. The request may also include a user profile of the associated user.

Optionally, at step 226, the mobile communications device may receive an acknowledgement that the request for access to the first network 102 has been granted with the user's network specific profile. At step 228, the mobile communications device switches from the profile for the second network 104 to the profile for the first network 102.

At step 230, upon successful authentication on the first network 102, the wireless network adapter used to access the first network 102 (e.g., radio circuit 36) is enabled and the wireless network adapter used to access the second network 104 (e.g., WLAN adapter 50) may be disabled. Voice and data communications occur between the mobile communications device and the first network 102 through radio circuit 36. Preferably, when the user of the mobile communications device places a call, the telephone call is transmitted in packet form through the first network 102.

Another exemplary method 250 for enabling multi-network access is illustrated in FIG. 7, the method includes, at step 252, providing a network having at least one input device (e.g., NFC device 62) for receiving near field communication (NFC) signals from an associated mobile communications device.

At step 254, a request for access to the provided network from an associated mobile communications device is received by the NFC input device. The request is transmitted by the mobile communications device upon placing the associated mobile communications device within an operable distance from the NFC reader 62. The request may include user's identity information associated with a user of the mobile communications device.

At step 256, the request is authenticated. The authentication may be based at least in part on the user's identity information that is transferred from the mobile communications device to the NFC input device. At step 258, user's identity information in the form of a user profile may be transferred from the associated mobile communications device to the second network 104. Preferably, an audio and/or video signal is output to the user of the mobile communications device based on the authentication step to indicate whether the user has been granted access to the second network 104. Upon successful authentication, the user of the mobile communications device is granted access to services available on the second network 104, such as originating and receiving voice calls or data connections through that network.

The methods discussed above preferably occur automatically when the mobile communications device comes within a distance “d” (as denoted in FIG. 3) of another NFC-compliant device. It is also preferable that the methods disclosed above occur seamlessly and without user intervention (other than placing the mobile communications device near the NFC input device). Thus, when the mobile communications device 10 comes within a distance “d” of another NFC-compliant device, a request for access to the second network 104 is transmitted by the mobile communications device. Upon successful authentication, the mobile communications device communicates using the wireless network adapter associated with the second network 104 (e.g., WLAN adapter 50) until the user leaves the coverage of the second network 104 or otherwise manually selects to cancel registration of the mobile communications device with the second network 104.

Upon the user leaving the coverage of the second network 104, the user may again place the mobile communications device within an operative distance of the NFC device 62. Such occurrence triggers termination of the VPN connection, an update of presence information on the first network 102 and de-registration of the most telephone from the second network 104. On the phone side, an indication that the user is no longer within the second network 104 is provided, which includes terminating the VPN connection to the network. The preferences of the mobile communications device for the first network 102 will be restored, or alternately a default profile or set of preferences may be loaded. For example, the mobile communications device will be restored to WWAN communications, the WLAN adapter may be turned off, information specific to the domain of the second network 104 (e.g. commercial data, access codes, etc.) may be removed, and calendar information may be handled according to user preferences. For example, the user may keep or remove the entries and/or show or hide the work calendar when the mobile communications device is not connected to the second network 104.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method for enabling multi-network usage of a mobile communications device, the method comprising:
providing a mobile communications device for access to a plurality of wireless networks, each with separate user access domains, the mobile communications device including a plurality of wireless network adapters for access the plurality of wireless networks, a near field communication (NFC) adapter, and a storage medium for storing network-specific user profile information to access a target network that is among the plurality of wireless networks;
transmitting a request for access to the target network, wherein the request is transmitted upon placing the mobile communications device within an operable distance from an associated NFC device, wherein the associated NFC device is communicably coupled to the target network.

2. The method of claim 1, wherein the request includes at least a portion of the user's identity information stored on the mobile communications device.

3. The method of claim 1, wherein the request includes a user profile of the associated user of the private network.

4. The method of claim 3, wherein the network specific user profile information is transferred from the target network to the mobile communications device through a near field communication protocol.

5. The method of claim 3, wherein the network specific user profile information is transferred from the target network to the mobile communications device through a wireless communication medium.

6. The method of claim 1 further including receiving an acknowledgement that the request for access to the private network has been granted.

7. The method of claim 6 further including disabling access to at least one other wireless network adapters upon receiving access to the target network.

8. The method of claim 7 further including receiving and transmitting communication signals with the associated target network through a wireless local area network (WLAN) adapter.

9. The method of claim 8 further including placing a telephone call from the mobile communications device wherein the telephone call is transmitted through a virtual target network (VPN) packet-switched connection established with the associated target network through the WLAN adapter.

10. The method of claim 6 further including exchanging data between the mobile communications device and the associated target network through a wireless local area network (WLAN) adapter.

11. The method of claim 10, wherein the data includes at least one item selected from the group consisting of: electronic mail (E-mail) messages, electronic calendar information, presence information or synchronization information.

12. The method of claim 11, wherein the data is push delivered from the target network to the WLAN adapter of the mobile communications device.

13. The method of claim 1 further including routing both outgoing calls originating from the mobile communications device and incoming calls to the mobile communications device through a wireless local area network (WLAN) adapter for output through the target network in packet form.

14. A method of enabling fixed mobile convergence, the method comprising:
providing a target network including at least one input device for receiving near field communication (NFC) signals from an associated mobile communications device;
receiving a request for access to the target network from the associated mobile communications device, wherein the request is transmitted upon placing the associated mobile communications device within an operable distance from an NFC device;
authenticating the request; and
transferring an user's identity information from the associated mobile communications device to the target network.

15. The method of claim 14, wherein the request includes user's identity information associated with a user of the mobile communications device.

16. The method of claim 15, wherein the step of authenticating the request is based at least in part on the user's identity information transmitted in the request.

17. The method of claim 14 further including outputting an audio and/or video signal to the associated user of the mobile communications device that the request for access to the associated target network has been granted.

18. The method of claim 14, wherein the user's identity information includes at least one item selected from the group consisting of: an user's identity name, a social security number, a user's identity number, a user profile or a unique identification associated with the user of the mobile communications device network.

19. The method of claim 18, wherein the user's identity information includes information to provide access to data from the target network to at least one data item selected from the group consisting of: electronic mail (E-mail) information, calendar information, virtual target network information, presence information or voice over Internet Protocol (VoIP) information.

20. The method of claim 19 further including push delivery of data from the target network to the associated mobile communications device.

21. The method of claim 20, wherein the data is transmitted to the associated mobile communications device through a wireless local area network (WLAN) interface.

22. The method of claim 14, wherein the target network receives information originating from telephone call from an electronic device and outputs the telephone call information to the associated mobile communications device through a wireless local area network (WLAN) interface.

23. A mobile communications device comprising:
a storage element for storing user identity information that facilitates fixed mobile convergence between a first network and a second network;
a near field communication (NFC) adapter;
a processor coupled to the storage element and the NFC adapter, wherein the processor is operable to control transferring of user network specific profile information to the NFC adapter when an associated NFC reader is within an operable distance to the mobile communications device, wherein the NFC adapter triggers transferring the user network specific profile when the mobile communications device moves from the first network to the second network.

24. The mobile communications device according to claim 23, wherein the storage element is removable.
